(19) United States
(12) Patent Application Publication
(10) Pub. No.: US 2026/0009879 A1
(43) Pub. Date: Jan. 8, 2026

(54) METHOD OF PROCESSING COMMUNICATION SIGNALS FOR USE IN RADAR SENSING, AND APPARATUS CONFIGURED TO EXECUTE THE METHOD

(71) Applicants: Continental Automotive Technologies GmbH, Hannover (DE); NANYANG TECHNOLOGICAL UNIVERSITY, Singapore (SG)

(72) Inventors: Rakshith JAGANNATH, Singapore (SG); Yong Liang GUAN; David GONZÁLEZ GONZÁLEZ, Frankfurt am Main (DE)

(73) Assignees: Continental Automotive Technologies GmbH, Hannover (DE); NANYANG TECHNOLOGICAL UNIVERSITY, Singapore (SG)

(21) Appl. No.: 18/992,250

(22) PCT Filed: Jul. 22, 2023
(86) PCT No.: PCT/IB2023/057481

§ 371 Date: Jan. 8, 2025

(30) Foreign Application Priority Data
Jul. 25, 2022 (DE) 102022118553.2

(51) Int. Cl. G01S 7/00; G01S 13/08; G01S 13/58; G01S 13/86; G01S 13/931

(52) U.S. Cl. CPC G01S 7/006; G01S 13/08; G01S 13/58; G01S 13/86; G01S 13/931; G01S 2013/9316

(57) ABSTRACT

A method of processing communication signals for use in radar sensing includes segmenting copies of a reference signal and a received echo thereof into first- and second-length segments, respectively. The first- and second-length segments are arranged in respective first and second reference and echo matrices. First and second segmented ambiguity functions based on the first and second matrix pairs are evaluated. For obtaining first and second range estimates and first and second velocity estimates for one or more targets. Any ghost signal detected is resolved, or an ambiguity order is assigned thereto if resolving is not possible. The obtained or resolved range and velocity estimates, or the estimates and the assigned ambiguity order is output, and the evaluation process is iteratively repeated until a termination criterion is met. In the second and each further iteration a respective remaining right-most non-zero columns of the echo matrices are replaced with zero-columns.

### CROSS REFERENCE TO RELATED APPLICATIONS

This application is the U.S. National Phase Application of PCT International Application No. PCT/IB2023/057481, filed Jul. 22, 2023, which claims priority to German Application No. 10 2022 118 553.2, filed Jul. 25, 2022, the contents of such applications being incorporated by reference herein.

### FIELD OF THE INVENTION

The present invention relates to methods of processing communication signals used for radar sensing, in particular to processing for resolving ghost peaks due to range folding. The invention further relates to a computer program product implementing the method, to a computer-readable storage medium storing the computer program product, to an apparatus configured to execute the method, and to a vehicle comprising such apparatus.

### BACKGROUND

Modern advanced driver assistance systems (ADASs) are becoming an increasingly important part of the modern intelligent transportation systems (ITS) to navigate efficiently and safely in a wide variety of complex and uncontrolled environments. Millimeter-wave (mmWave) radars are a key component in the design of ADASs and self-driving cars and are already employed in safety equipment such as adaptive cruise control, automatic emergency brake, lane change and park assistance, cross traffic alert, blind spot detection, and collision warning, etc. Today, automotive mmWave radar technology can operate under adverse weather and light conditions and have the unique ability to simultaneously measure the delay, radial velocity, and azimuth and elevation angles of arrival of multiple targets within a single coherent processing interval (CPI), thus allowing the construction of a four-dimensional image of the environment.

Recent advances in mmWave communications and the wireless standardization efforts in the current fifth generation (5G) standard is opening up the possibility of integrating the radar and communication functions in the deployment of future smart cities and smart roads.

The broad paradigm of integrating the radar and communication functions is referred to as joint radar and communications (JRC), and is widely recognized as a novel paradigm for 6G.

As schematically illustrated in FIG. 1, the current mmWave vehicular radar transmits short-pulse frequency-modulated continuous wave (FMCW) signals, also referred to as chirp-signals, which are reflected by objects, also referred to as targets. The reflected signals are referred to as “radar echoes”. The radar receiver then processes these received radar echoes for radar sensing. The radar sensing operation pertains to the determination of the relative range, or distance, and relative velocities of the different objects in a current environment.

Similarly, vehicular communication systems transmit signals used to transfer information between vehicles and between vehicles and infrastructure. These communication signals are likewise reflected back to the transmitter, also referred to as egovehicle, by surrounding objects as a “communication signal echo”, as schematically illustrated in FIG. 2. The communication signals and the radar signals may operate in similar radio bands and may have similar propagation and reflection properties. Hence, this “communication echo” can also be used for radar sensing. The term egovehicle is used throughout this specification for a vehicle that transmits, receives and processes reflected signals for radar sensing. In FIGS. 1 and 2 solid arrows indicate a transmitted signal, whereas dashed arrows indicate a reflected signal, or “echo”.

In an aspect of the present invention the JRC system implementation shown in FIG. 2 is considered. The communication systems of the JRC system considered herein are left unaltered and the “communication echoes” are used for radar sensing, in particular for range and velocity estimation. The maximum detectable range is the maximum distance of a target from the radar that the radar can successfully detect, or sense. Similarly, the maximum detectable velocity is the maximum relative velocity of the target which, with respect to the transmitter, the radar can successfully detect, or sense.

It is well known that the maximum detectable range and the maximum detectable velocity are coupled. In other words, for the same transmit pulse duration, increasing the maximum detectable range decreases the maximum detectable velocity and vice versa, because the maximum detectable range is directly proportional to the duration of the transmit pulse, or burst, and the maximum detectable velocity is inversely proportional to the duration of the transmit pulse, or burst.

Typically, communication signals are designed for achieving high data rates. So, in one coherent processing interval (CPI) a large number of short-duration communication pulses, or bursts, are transmitted.

Assuming an operation bandwidth be B results in a sampling rate, or symbol duration,

$${T}_{C} = \frac{1}{B} .$$

Denoting the center frequency as f_{c} the wavelength is

$$λ = \frac{c}{{f}_{c}} ,$$

c being the speed of light in vacuum. Further, let the transmit signal duration, or frame duration, be T_{f}=NT_{c}, hence it is assumed that N samples are transmitted.

Radar sensing can be performed by evaluating the full ambiguity function (full-AF). However, the complexity of the full-AF is of the order of ≈O(N²).

Since the duration of a pulse, or burst, of communication signals is very short, the maximum detectable range of radar sensing using the communication echo is limited. Furthermore, when the true target range is greater than the maximum detectable range, targets which are located at a distance greater than maximum detectable range appear as ghosts, resulting in ambiguity, which may result in a wrong range estimate. The appearance as ‘ghost’ is shown in FIG. 3.

The mmWave vehicular radars which use the FMCW chirp signal also encounter the problem of small maximum detectable velocity. This is due to the fact that in the chirp radars, the chirp duration is fixed just long enough to ensure that the maximum detectable range satisfies the requirement of vehicular radar standards.

To solve this problem, two transmissions with different pulse repetition frequencies (PRFs) for extending the maximum detectable velocity may be used. This concept cannot properly be adapted for JRC systems which use the communication waveforms for radar sensing, and which are confronted with the need to extend the maximum detectable range.

There is thus a need for a method of processing communication signals to reduce or suppress ambiguity when such communication signals are used for radar sensing.

Throughout this specification, bold lower-case letters as in a are used to denote vectors and bold upper-case letters as in A are used for denoting matrices. a⊙b denotes the Hadamard product, i.e., the element-wise multiplication, of two vectors a and b and a⊗b denotes the Kronecker product of two vectors a and b. * indicates the complex conjugate operation, where every entry in a matrix A* is the complex conjugate of the corresponding entry A.

### SUMMARY OF THE INVENTION

In accordance with a first aspect of the invention a novel method of detecting and resolving ghost peaks that appear, due to range folding, in a radar sensing image obtained using the non-chirp communication echoes is proposed. The proposed method uses only a single transmit signal, whose received communication echo is processed twice. The proposed method is based on a dual-segmentation method for detecting the ghosts, followed by the application of the Chinese remainder theorem (CRT) to resolve the ghost peaks in one or more embodiments of the method.

In accordance with a second aspect of the present invention a wireless communication device is provided, which implements the method according to the first aspect.

In accordance with a third aspect of the present invention a computer program product is provided, which comprises computer instructions that configure a wireless communication device or a computer system communicatively connected thereto to execute the method in accordance with the first aspect.

In accordance with a fourth aspect a computer readable medium is provided, which stores the computer program product.

In accordance with a fifth aspect of the present invention a vehicle is provided, comprising a receiver according to the second aspect.

Prior to describing the method in accordance with an aspect of the invention the signal model describing the relationship of the received communication echo signal to the target range and target Doppler will be developed.

It is assumed that the transmit signal used for radar purpose is a communication signal which follows a communication standard, for example, the IEEE 802.11ad OFDM (orthogonal frequency division multiplex) PHY (physical) standard.

A transmitted OFDM waveform in the block form can be represented as,

$${s}_{o} ( t ) = {\sum }_{m = 0}^{M - 1} {\sum }_{k = 0}^{K - 1} C [ mK + k ] {e}^{( j 2 π k Δ Ft )} p ( t - {mKT}_{c} ) ,$$

where

$$Δ F = \frac{1}{KT}$$

is the sub-carrier spacing, p (t) is the rectangular pulse-shaping waveform, M is the number of OFDM blocks, K is the number of sub-carriers, C[mK+k] is the symbol in the k-th sub-carrier of block m.

The transmitted signal is reflected by multiple point-like targets and is received by the JRC radar system as “communication echoes”. The received signal can be expressed as,

$$\tilde{{r}_{o}} ( t ) = {\sum }_{l = 1}^{L} {\sum }_{m = 1}^{M - 1} {\sum }_{k = 1}^{K - 1} {α}_{l} C [ mK + k ] {e}^{( j 2 π k Δ F ( t - {τ}_{l} ) + j 2 π {f}_{l} t )} p ( t - {τ}_{l} - {mKT}_{c} )$$

where L is the number of targets, u is the delay of the communication echo due to target l and fₗ is the corresponding Doppler shift, at is the attenuation of the communication echo from target l. The time-domain signal model of this equation can be simplified further by processing in the frequency domain. Taking the Fourier transform of the received signal, \tilde{r}ₒ can be expressed as

$${r}_{o} ( f ) = {\sum }_{l = 1}^{L} {\sum }_{m = 0}^{M - 1} {\sum }_{k = 0}^{K - 1} {α}_{l} C [ mK + k ] \int {e}^{( j 2 π k Δ F ( t - {τ}_{l} ) )} p ( t - {τ}_{l} - {mKT}_{c} ) {e}^{j 2 π {f}_{l} t} {e}^{- j 2 π ft} dt$$

On further manipulations this equation can be reduced to

$${r}_{o} ( f ) = {\sum }_{l = 1}^{L} {\sum }_{m = 0}^{M - 1} {α}_{l} {e}^{- j 2 π f {τ}_{l}} {e}^{j 2 π {f}_{l} {mKT}_{c}} {\sum }_{k = 0}^{K - 1} C [ mK + k ] {e}^{- j 2 π {fmKT}_{c}} .$$

### Define

$${c}_{m} = [ \begin{matrix}C ( mK + 0 ) \\ ⋮ \\ C ( K + mK - 1 )\end{matrix} ] , {ω}_{τ} ( {τ}_{l} ) = [ \begin{matrix}1 \\ {e}^{- j 2 π 1 ( \frac{{τ}_{l}}{{KT}_{c}} )} \\ ⋮ \\ {e}^{- j 2 π ( K - 1 ) ( \frac{{τ}_{l}}{{KT}_{c}} )}\end{matrix} ] ,$$

$${ω}_{f} ( {f}_{l} ) = [ \begin{matrix}1 \\ {e}^{- j 2 π 1 ( {f}_{l} {KT}_{c} )} \\ ⋮ \\ {e}^{- j 2 π ( M - 1 ) ( {f}_{l} {KT}_{c} )}\end{matrix} ] , {r}_{m} = [ \begin{matrix}{r}_{m} ( mK + 0 ) \\ ⋮ \\ {r}_{m} ( K + mK - 1 )\end{matrix} ] ,$$

$$r = [ \begin{matrix}{r}_{0} \\ ⋮ \\ {r}_{M - 1}\end{matrix} ] , c = [ \begin{matrix}{c}_{0} \\ ⋮ \\ {c}_{M - 1}\end{matrix} ] .$$

After discretizing the received signal and using the notations provided further above and stacking the received vectors from each block, r can be expressed as

$${r}_{KM \times 1} = {c}_{KM \times 1} ⊙ {\sum }_{m = 0}^{L - 1} {α}_{l} ( {ω}_{τ} ( {τ}_{l} ) ⊗ {ω}_{f} ( {f}_{l} ) ) .$$

The signal model developed hereinbefore describes the relationship of the received communication echo signal to the target range and target Doppler and will be used in the following description of the inventive method of processing communication signals for radar sensing, for estimating the target range and velocity.

The goal of the radar sensing method in accordance with an aspect of the invention is to estimate the range and the velocity of each of the L targets from the received signal. A matched filter based method is used for radar sensing in an aspect of the invention.

The inventive method uses the received echo signal and a copy of the clean transmit signal, also referred to as reference signal, for processing. In a first step, the received echo samples and the clean transmit samples are split into M segments, with each segment consisting of K samples, as shown in FIG. 4.

The samples of segment m, 0≤m≤M−1 from the received echo signal and the clean transmit signal, in the time domain, are then stored in the column m of the matrices \tilde{R} and \tilde{C}, respectively. Each of these matrices is of size K×M. In the second step, the received echo samples and the clean transmit samples are converted to frequency domain. This is accomplished by a K point FFT on all M columns of \tilde{R} and \tilde{C} to obtain \tilde{R} and \tilde{C}, respectively. In the next step, an element-wise multiplication of matrix \tilde{R} with the complex conjugate of matrix C̅ obtains R̅. The final steps of the algorithm involve evaluation of the range IFFT over the columns of R̅ to obtain Ř. This is followed by the Doppler FFT over rows of Ř to obtain the radar sensing image or the segmented ambiguity function (segmented AF) \hat{R}.

The method steps for evaluating each of the segmented ambiguity functions are summarized below:

Inputs: The received echo samples \tilde{r} and the clean transmit samples, C[mK+k], 0≤k≤K−1 and 0≤m≤M−1.

Segmentation: Segment the received echo samples and the clean transmit samples, as shown in FIG. 4, to form the matrices \tilde{R} and \tilde{C}, respectively, in the time domain.

FFT-1: Take the FFT of columns of \tilde{R} and \tilde{C} to obtain R̅ and C̅, respectively, in the frequency domain.

Pre-processing: Perform the operation R̅=R̅⊙C̅*.

FFT-2: Take the IFFT of columns of R̅ to form Ř.

FFT-3: Take the FFT of rows of Ř to form the matrix \hat{R}, which is the segmented AF.

Peak Search: Perform a peak search on the matrix \hat{R}.

Output: τₗ, fₗ correspond to row(s) and column(s) of peak-l in \hat{R}.

The output of the matched filter is called the ambiguity function (AF). In an aspect of the invention, since it suggests radar sensing using a matched filter by segmentation of the received echo signal and the clean transmit signal, the radar sensing output is referred to as segmented AF output.

It can be observed that the method for evaluating the segmented ambiguity function uses only FFTs for range and velocity estimation. Hence, it operates with a low complexity of O (N log KN). The peaks in the segmented AF correspond to the range and velocity estimates of the target(s). The maximum detectable range and the maximum detectable velocity using the segmented AF radar sensing algorithm are given by,

$${R}_{max} = \frac{{KcT}_{c}}{2}$$

$${V}_{max} = \frac{λ}{4 {KT}_{c}} ,$$

where

$${T}_{c} = \frac{1}{B}$$

is the sampling interval, with B being the operation bandwidth, c is the speed of light in vacuum and λ is the wavelength of the communication signal, determined from the center frequency f_{c} through

$$λ = \frac{c}{{f}_{c}} .$$

When the target location is greater than Rₘₐₓ, ghosts appear in the segmented AF due to the folding of the range estimate as shown in FIG. 3.

In the following section detecting and resolving these ghost peaks will be discussed. Detecting and resolving the ghost peaks in the segmented AF involves an iterative repetition of method steps. The proposed method uses only the received echo signal and a copy of the clean transmit signal (reference signal) and the number of iterations (Pₒ) as inputs for processing.

An aspect of the invention uses the finding that, for a target whose range is greater than the maximum detectable range (Rₘₐₓ), segmentation with different segment lengths (K₁ and K₂) produces ghosts at different locations in the respective segmented AF. The proposed method uses this finding for detecting the ghost(s).

Hence, in accordance with the inventive method, the received echo signal and the clean transmit signal are split into segments with different respective segment lengths K₁ and K₂, respectively, and, at each iteration, two corresponding segmented AFs are evaluated.

In light of the foregoing discussion, it is obvious that, if the true target range r≤Rₘₐₓ, the two segmented AFs will produce the same peak or a single range estimate for each of the targets.

However, as mentioned before, if the true target range r>Rₘₐₓ, ghost peaks will occur at different locations in the two segmented AFs, which results in an ambiguity in the estimated target range. In accordance with an aspect of the invention the Chinese remainder theorem (CRT) is applied for resolving the range ambiguity in the ghost peaks of the two range estimates from the two segmented AFs.

The main steps of the proposed dual-segment processing method are as follows: In the first step, the clean transmit signal is pre-processed. This is achieved by using two copies of the clean transmit samples and creating two segmentations of length K=K₁ and K=K₂≤K₁, respectively. It is assumed that the number of segments of length K₁ obtained from the first segmentation is M₁ and the number of segments of length K₂ obtained from the second segmentation is M₂, respectively. The samples obtained from first segmentation are stored in the matrix \tilde{C}₁ and the samples obtained from the second segmentation are stored in the matrix \tilde{C}₂.

The size of the matrix \tilde{C}₁ is K₁×M₁ and the size of the matric \tilde{C}₂ is K₂×M₂. The matrices \tilde{C}₁ and \tilde{C}₂ are now used for evaluating the segmented AF-1 and the segmented AF-2, respectively.
Perform segmentation on the first copy of ŕ to obtain M₁ segments, each of length K=K₁. Similarly, perform segmentation on the second copy of \tilde{r} to obtain M₂ segments, each of length K=K₂. The samples obtained from the first segmentation are stored in matrix \tilde{R}₁ and the samples obtained from the second segmentation are stored in matrix \tilde{R}₂, respectively. The size of matrix \tilde{R}₁ is K₁×M₁ and the size of the matrix \tilde{R}₂ is K₂×M₂, respectively.

The next steps of the proposed dual-segment processing method are repeated iteratively until a termination criterion is met. For example, the method may terminate after completing P₀ iterations, where P₀ is predefined. At each iteration step P of the algorithm, the following steps are performed using two copies of the received signal samples \tilde{r},
Right-shift the received segment buffer by (P−1) segments. Equivalently, discard the first (P−1) columns of \tilde{R}₁ and \tilde{R}₂. Then append (P−1) columns of zeros as the last columns of \tilde{R}₁ and \tilde{R}₂.
Evaluate the first segmented ambiguity function (AF-1) by using \tilde{R}₁, \tilde{C}₁ as inputs to the first Fourier transform step of the method for evaluating the segmented ambiguity functions to obtain \hat{r}ₗ and \hat{v}ₗ as the range and velocity estimates for target l. Similarly, evaluate the second segmented ambiguity function (AF-2) by using \tilde{R}₂, \tilde{C}₂ as inputs to the first Fourier transform step of the method for evaluating the segmented ambiguity functions to obtain \dot{r}ₗ and \dot{v}ₗ as the range and velocity estimates for target l. Note that the circumflex and the dot are used for distinguishing the two segmentations.
   If the segmented AFs produce no peaks, then we move to the next iteration, i.e., iteration P+1.
   If the range estimates \hat{r}ₗ=\dot{r}ₗ, then it implies that these are not ghosts and hence are the estimates of true targets. Hence, no further processing is required and \hat{r}ₗ and \hat{v}ₗ are set as the output at iteration P, and the method proceeds to the next iteration, i.e., iteration P+1.
   If the range estimates \ddot{r}ₗ≠\dot{r}ₗ, then the peaks in the segmented AF are due to the ghosts. If the velocity estimates \hat{v}ₗ are all different, the ghost peaks of segmented AF-1 and segmented AF-2 can be paired using the velocities, and the CRT method described in detail further below can be applied to estimate the ambiguity order \hat{m}ₗ. \hat{r}ₗ+\hat{m}ₗR_{max,1} and \hat{v}ₗ are set as the output at iteration P and the method proceeds to the next iteration, i.e., iteration P+1.
   If the range estimates \hat{r}ₗ≠\dot{r}ₗ, and if some of the velocity estimates \hat{v}ₗ are equal, then peak pairing is not possible. In this case the ambiguity order is set as \hat{m}ₗ=(P−1) and \hat{r}ₗ+\hat{m}ₗR_{max,1} and \hat{v}ₗ are output at iteration P, and the method proceeds to the next iteration, i.e., iteration P+1.
If iteration P=P₀, the method terminates.

The steps of the proposed dual-segment processing method are summarized below, for an exemplary process using a maximum number of iterations as termination criterion:
Inputs: The received samples f and the clean transmit samples, C[mK+k], with 0≤k≤K−1 and 0≤m≤M−1. The parameters K₁, M₁, K₂ (≤K₁) and M₂, the maximum number of iterations P₀ (determined by the desired Rₘₐₓ).
Pre-processing: Generate two segmentations of the clean transmit samples of length K₁ and K₂ as follows,
i) Collect first K₁ consecutive samples to form segment-1(K=K₁), then the next K₁ samples to form segment-2 (K=K₁), continue this process M₁ times. Form the matrix \tilde{C}₁ of size M₁×K₁ from these segments.
ii) Collect the first K₂ consecutive samples to form segment-1(K=K₂), then the next K₂ samples to form segment-2 (K=K₂), continue this process M₂ times. Form the matrix \tilde{C}₂ of size M₂×K₂ from these segments.
iii) Collect the first K₁ consecutive samples to form segment-1(K=K₁), then the next K₁ samples to form segment-2 (K=K₁), continue this process M₁ times. Form the matrix \tilde{R}₁ of size M₁×K₁ from these segments.
iv) Collect the first K₂ consecutive samples to form segment-1(K=K₂), then the next K₂ samples to form segment-2 (K=K₂), continue this process M₂ times. Form the matrix \tilde{R}₂ of size M₂×K₂ from these segments.
Iterate: For iteration P=1 to P₀, perform the following steps using two copies of the received echo samples,
1) Remove the first P−1 columns from \tilde{R}₁, \tilde{R}₂. Append (P−1) columns of zeros to \tilde{R}₁, \tilde{R}₂ at the end.
2) With the matrix \tilde{R}₁ and \tilde{C}₁ as input to the FFT-1 step of the method for evaluating the segmented ambiguity functions, evaluate the segmented AF-1 and obtain the range and Doppler estimates, (\hat{r}ₗ, \hat{v}ₗ) for target l.
3) With the matrix \tilde{R}₂ and \tilde{C}₂ as input to the FFT-1 step of the method for evaluating the segmented ambiguity functions, evaluate the second segmented AF and obtain the range and Doppler estimates, (\dot{r}ₗ, \dot{v}ₗ) for target l.
4a) Case 1: If the segmented AFs produce no peaks (equivalently if there are no estimates), move to iteration P+1.
4b) Case 2: If \hat{r}ₗ=\dot{r}ₗ, \hat{r}ₗ and \hat{v}ₗ are set as the output at iteration P and the method proceeds to the next iteration (iteration P+1).
4c) Case 3: If \hat{r}ₗ≠\dot{r}ₗ and \hat{v}ₗ are all different, the ghost peaks (\hat{r}ₗ, \hat{v}ₗ) are paired to (\dot{r}ₗ, \dot{v}ₗ) using the fact that \hat{v}ₗ=\dot{v}ₗ. The method implementing the CRT is executed with each of the paired peaks as inputs to estimate the ambiguity order m for target l. \hat{r}ₗ+\hat{m}ₗR_{max,1} and \hat{v}ₗ and \hat{v}ₗ are set as the output at iteration P, and the method proceeds to the next iteration (iteration P+1).
4d) Case 4: If \hat{r}ₗ≠\dot{r}ₗ and if some of the velocity estimates \hat{v}ₗ are equal, set \hat{m}ₗ=(P−1), output \hat{r}ₗ+\hat{m}ₗR_{max,1} and \hat{v}ₗ at iteration P, and proceed to the next iteration (iteration P+1).
5) At iteration P₀, all the ghosts within the range P₀Rₘₐₓ are resolved.

It is noted that the proposed dual-segment processing method has a complexity of O ((N log KN) 2P₀). Hence, with an increase in complexity, the ghost peaks which occur due to targets within range r=P₀Rₘₐₓ are resolved. Using waveforms which follow mmWave communication standards, P₀ is usually small, e.g., P₀≈≤5, for vehicular radar requirements. Hence, the increase in complexity to resolve the ghost peaks is small.

It is also noted that it is beneficial to perform some modifications on the OFDM reference signal samples for evaluation of the segmented AF. The first modification is to replace the cyclic prefix (CP) transmit OFDM signal to zero, or equivalently setting the CP to a zero-prefix (ZP). The second modification is to set the trailing symbols of the transmit OFDM signal which are copied to create the CP, to zero. These modifications on the OFDM time-domain reference samples ensure better side-lobe suppression in the segmented AF and hence result in a better range-velocity estimates.

Thus, in accordance with the first aspect of the invention, a method of processing communication signals for use in radar sensing comprises:
a) receiving a reflected communication signal, wherein the reflected received communication signal is a reflection of a transmitted communication signal, and storing the received communication signal in a receiver buffer,
b) retrieving a copy of the transmitted communication signal, representing a reference signal, from a reference buffer,
c) segmenting the reference signal into a first segment-number of first-length segments and segmenting the reference signal into a second segment-number of second-length segments, and arranging the first-length and the second-length segments in respective first and second reference signal matrices,
d) segmenting the received communication signal into a first segment-number of first-length segments and segmenting the received communication signal into a second segment-number of second-length segments, and arrange the first-length and the second-length segments in respective first and second received communication signal matrices,
e) evaluating first and second segmented ambiguity functions based on the first and second received communication signal matrices and the corresponding first and second reference signal matrices, respectively,
f) obtaining, from the first and second segmented ambiguity functions, first and second range estimates and first and second velocity estimates, for one or more targets,
g) on any obtained first and second range and/or first and second velocity estimate, determining if ghost signals are present in the estimates and, in the positive case, resolving the ghost signals or assigning an ambiguity order to the estimates,
h) outputting obtained or resolved range and velocity estimates, or the estimates and the assigned ambiguity order,
i) iteratively repeating steps e) to h) until a termination criterion is met wherein, in the second and each further iteration the left-most column of the first and second received communication signal matrices are removed and corresponding right-most zero-columns are appended.

In one or more embodiments of the method segmenting the reference signal and the received communication signal comprises collecting a first-length number of consecutive samples of the respective signal to form segments of the first length, and repeating the previous step the first segment-number times. Then, respective matrices of size first segment-number×first length are formed for the reference signal and for the received communication signal from the corresponding segments. The same procedure is carried out again using a second-length number of consecutive samples of the respective signal to form segments of the second length, and repeated the second segment-number times. Finally, respective matrices of size second segment-number×second length are formed for the reference signal and for the received communication signal from the corresponding segments.

In one or more embodiments evaluating the first and second segmented ambiguity function comprises performing a first Fourier transform on the columns of the received communication signal matrices and the reference signal matrices, for obtaining corresponding matrices in the frequency domain. Then, the Hadamard product of the received communication signal matrices and the reference signal matrices is determined, for obtaining first further matrices representing the received communication signal in the frequency domain. Next, a first inverse Fourier transform is performed on the columns of the first further matrices representing the received communication signal to form corresponding second further matrices representing the received signal in the time domain. A second Fourier transform is then performed on the rows of the second further matrices representing the received signal to obtain matrices representing the first and the second segmented ambiguity function, respectively. Finally, peak searches are performed on the matrices representing the first and the second segmented ambiguity function, prior to outputting information representing the range and the velocity corresponding to the peaks found in the preceding step.

In one or more embodiments obtaining first and second range estimates and first and second velocity estimates for one or more targets from the first and second segmented ambiguity functions comprises determining if the first and/or second segmented ambiguity functions exhibit peaks that exceed a predetermined threshold and, in the negative case, proceeding to the next iteration

In the following section the method steps of a practical implementation for resolving range ambiguity using CRT will be discussed. It is recalled that different range estimates may be present after evaluating the two segmented AFs as discussed above in the proposed dual-segment processing method. These folded estimates are denoted as estimates \hat{r}ₗ and \dot{r}ₗ, respectively, and r_{d} is the true target range. Hence,

$${r}_{d} = \hat{r} + {m}_{1} {R}_{max , 1}$$

$${r}_{d} = \dot{r} + {m}_{2} {R}_{max , 2}$$

where

$${R}_{max , 1} = \frac{{K}_{1} c}{2 B} and {R}_{max , 2} = \frac{{K}_{2} c}{2 B}$$

are the maximum ranges corresponding to the segmentation-1 and segmentation-2 respectively. The above equations can be expressed as congruence equations as,

$${r}_{d} = \hat{r} + mod ( {R}_{max , 1} )$$

$${r}_{d} = \dot{r} + mod ( {R}_{max , 2} )$$

Applying the CRT the congruences can be solved to obtain r_{d}. Practically, for estimating ambiguity order the CRT can be applied to the dual-segmentation processing by executing the following steps:
Inputs: \hat{r} and \dot{r}.
Grid: Make a grid for m₁ and m₂ for the possible ambiguity orders m₁, m₂=1, 2, . . . , P₀.
Cost Evaluation: For each grid point (m₁, m₂), evaluate the cost function J(m₁, m₂)=|(T)+\hat{m}ₗR_{max,1})−(\dot{r}ₗ+\hat{m}₂ R_{max,2})|.
Output: The grid point (m₁, m₂) corresponding to the minimum cost J(m₁, m₂) is the required ambiguity order.

Accordingly, in one or more embodiments determining if ghost signals are present in the range and/or velocity estimates comprises segment-wise comparing the first and second range estimates and, if the first and second range estimates for a set of corresponding segments correspond, outputting the range and velocity estimates for the one or more targets for this iteration. If the first and second range estimates for a set of corresponding segments do not correspond and the first velocity estimates are all different, the first and second range and velocity estimates are paired for each target based on their respective velocity estimates, and an ambiguity order is determined. Then, the first velocity estimate and a range estimate for this iteration is output, with the range estimate being assigned an ambiguity term determined using the Chinese remainder theorem (CRT) method. If the first and second range estimates for a set of corresponding segments do not correspond and some of the first velocity estimates are equal, an ambiguity order is set to the number of the current iteration minus 1, and the first velocity estimate and a range estimate is output, with the range estimate being assigned an ambiguity order.

In one or more embodiments, when the communication signal is a single carrier signal, the reference signal is a plain copy of the transmitted signal.

In one or more embodiments, when the communication signal is an OFDM signal, the reference signal is a modified copy of the transmitted communication signal, in which a cyclic prefix in the copy of the transmitted communication signal is replaced with zero or the cyclic prefix is replaced with a zero-prefix prior to segmenting. Additionally, or alternatively, the trailing symbols of the transmit OFDM symbol that are used for a cyclic prefix in the transmitted communication signal are set to zero.

In accordance with a second aspect of the present invention a wireless communication device configured to execute the method discussed hereinbefore is presented. The wireless communication apparatus comprises one or more software and/or hardware blocks configured for transmitting a wireless communication signal and to receive copies of the transmitted wireless communication signal reflected off of one or more physical objects, and for processing the communication signals for use in radar sensing in accordance with the method presented hereinbefore.

The method described hereinbefore may be represented by computer program instructions. Accordingly, a computer program product comprises computer program instructions which, when executed by a microprocessor of a wireless communication device, cause the microprocessor to execute methods in accordance with the first or third aspects of the present invention, and to accordingly control hardware and/or software blocks or modules of the wireless communication device in accordance with the second aspect of the invention as presented above.

The computer program instructions may be retrievably stored or transmitted on a computer-readable medium or data carrier. The medium or the data carrier may by physically embodied, e.g., in the form of a hard disk, solid state disk, flash memory device or the like. However, the medium or the data carrier may also comprise a modulated electro-magnetic, electrical, or optical signal that is received by the computer by means of a corresponding receiver, and that is transferred to and stored in a memory of the computer.

An aspect of the present invention proposes a valid novel method for detecting and resolving ghost peaks due to range folding in radar sensing images obtained using regular communication signal echoes, i.e., not relying on specific chirp signals specifically designed for radar purposes.

The proposed method is based on dual-segmentation, leveraging the fact that different segmentations of the same single received signal produce different ghost peaks of the true object location in the AF radar image. However, the segmented AF algorithm reduces both the maximum detectable range Rₘₐₓ and the maximum detectable velocity Vₘₐₓ. The segment length, K affects Rₘₐₓ and Vₘₐₓ that can be detected. Increasing K increases the Rₘₐₓ but decreases the Vₘₐₓ. Hence, a good choice of K is necessary to ensure that the requirements of vehicular radar are satisfied. The segment length K is limited by the size of the FFT available for processing. Even when the segment length K is chosen as the maximum FFT size which is easily available, the achievable Rₘₐₓ may be less than the vehicular radar requirement. A target whose range is greater than the achievable Rₘₐₓ is folded and appears as a ghost target in the radar sensing output. In accordance with the proposed method the Chinese remainder theorem (CRT) is used to provide an efficient solution to detect and resolve the ghosts, which makes the method suitable to be implemented in V2X automotive systems as they are transparent to the communication part. Simulations using IEEE 802.11ad OFDM-PHY frames show the validity of the proposed methods. The proposed methods can detect and resolve ghost peaks which occur due to targets within range r=P₀Rₘₐₓ with a complexity of O ((N log KN)2P₀), which is significantly smaller than the complexity of a common full AF at O (N² log N+N²). Using waveforms which follow mmWave communication standards, comprehensive and exhaustive simulations have shown that the value of P₀ for achieving a range of around 300 m is usually small P₀≈≤5 for vehicular radar requirements. Hence, having a complexity of O (10 (N log KN)) the proposed algorithm increases the sensing capability of the target range by P₀ times with a small (linear) increase in the complexity over the common full AF.

The segmented-AF based method can be used by both single carrier (SC) and orthogonal frequency division multiplexing (OFDM) signals for radar sensing, in any wireless communication system environment, in particular in 5G and 6G communication systems and beyond, in indoor and outdoor environments, including industrial scenarios. Note that, while the clean reference signal for an SC communication signal is a copy of the transmitted signal, the clean reference signal for an OFDM communication signal is a modified transmitted signal, as discussed by the same inventors in the International patent application PCT/EP2022/085092, which is hereby incorporated by reference.

Although aspects of the invention have been described hereinbefore mostly with reference to IEEE 802.11-type communication the underlying concept can be applied to all kinds of cellular and vehicular communications.

### BRIEF DESCRIPTION OF THE DRAWING

Aspects of the invention will now be described with reference to the drawing, in which

FIG. 1 schematically illustrates a vehicle having separate communication and radar equipment,

FIG. 2 schematically illustrates reflected communication signals transmitted by a vehicle arriving at a radar equipment,

FIG. 3 schematically illustrates the appearance of a ghost signal due to folding,

FIG. 4 schematically illustrates the segmentation of the echo signal and the reference signal,

FIG. 5 shows a first exemplary relative placement of objects for JRC detection,

FIGS. 6A and 6B show the segmented ambiguity functions for different segment lengths for the first exemplary relative placement of objects of FIG. 5 for the first iteration,

FIGS. 7A and 7B show the segmented ambiguity functions for different segment lengths for the first exemplary relative placement of objects of FIG. 5 for the second iteration,

FIG. 8 shows a second exemplary relative placement of objects for JRC detection,

FIGS. 9A and 9B show the segmented ambiguity functions for different segment lengths for the second exemplary relative placement of objects of FIG. 8 for the first iteration,

FIGS. 10A and 10 B show the segmented ambiguity functions for different segment lengths for the second exemplary relative placement of objects of FIG. 8 for the second iteration,

FIG. 11 shows a third exemplary relative placement of objects for JRC detection,

FIGS. 12A and 12B show the segmented ambiguity functions for different segment lengths for the third exemplary relative placement of objects of FIG. 11 for the first iteration,

FIGS. 13A and 13B show the segmented ambiguity functions for different segment lengths for the third exemplary relative placement of objects of FIG. 11 for the second iteration,

FIG. 14 shows a basic schematic flow diagram of the inventive method,

FIG. 15 shows a further representation of an exemplary flow diagram of the inventive method,

FIG. 16 shows yet another, more detailed representation of an exemplary flow diagram of the inventive method, and

FIG. 17 shows a schematic block diagram of an exemplary wireless communication apparatus configured for executing the inventive method.

In the figures identical or similar elements may be referenced using the same reference designators.

### DETAILED DESCRIPTION OF EXEMPLARY EMBODIMENTS

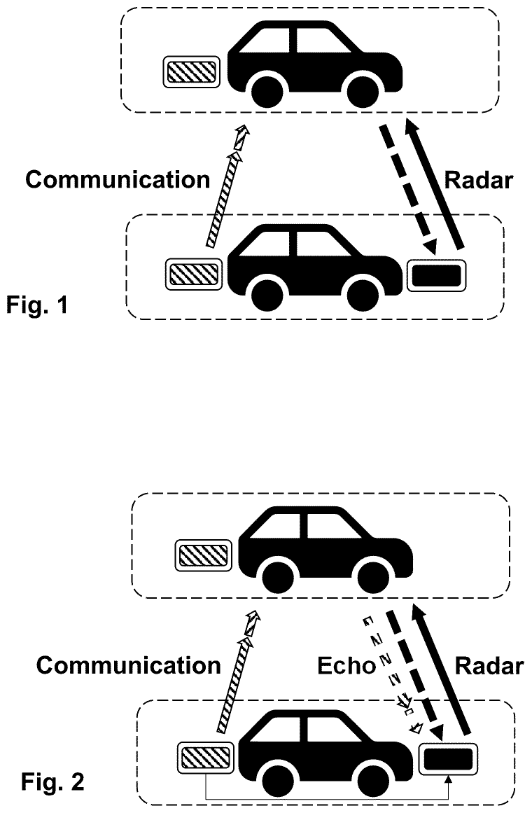

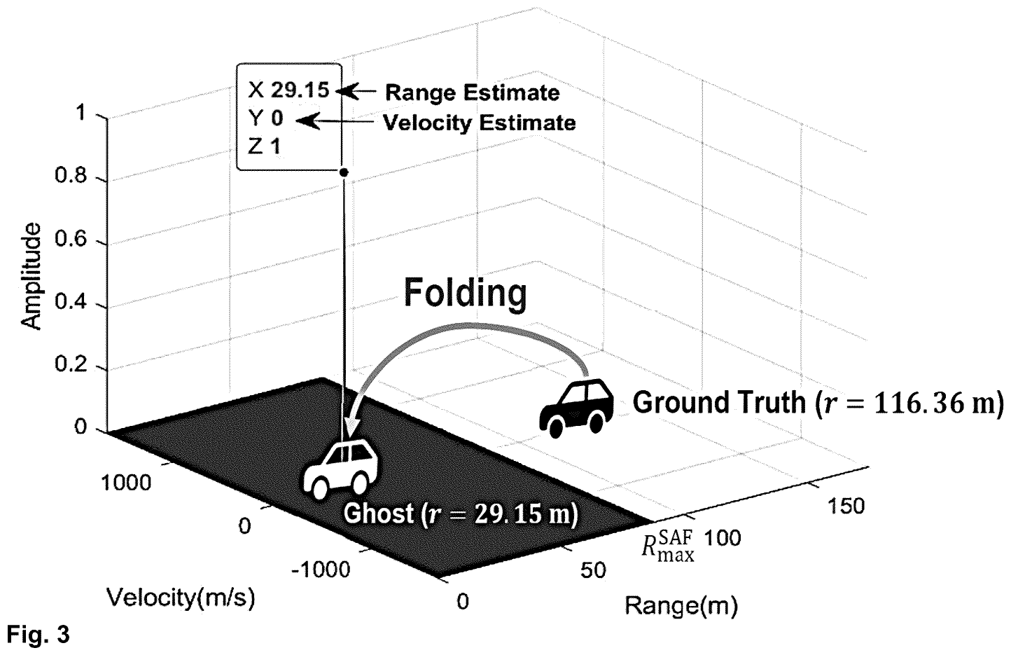

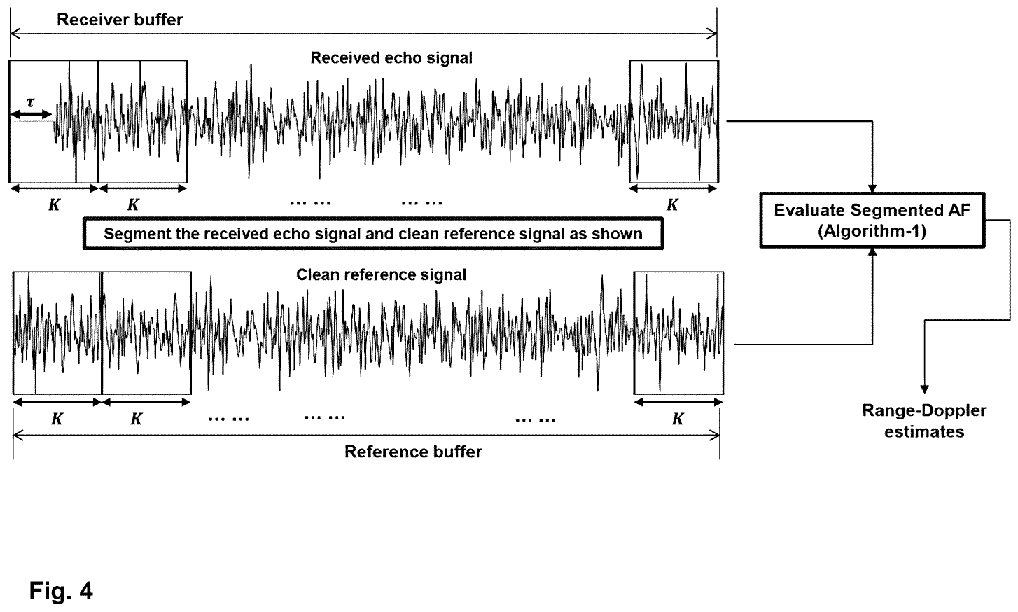

FIGS. 1 to 4 have already been discussed further above and will not be addressed again.

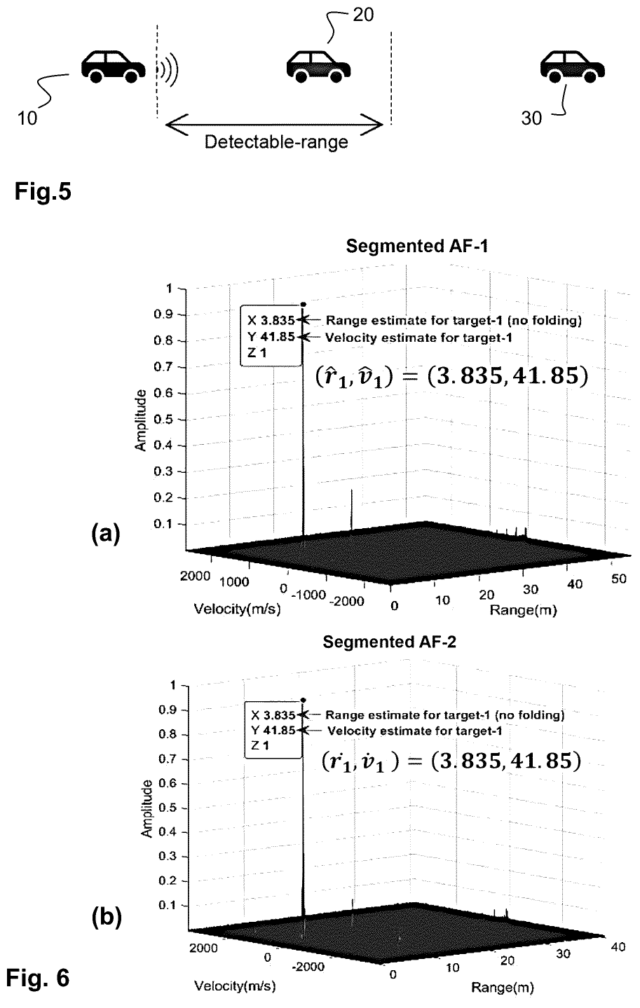

FIGS. 5, 8 and 11 show different practical scenarios in which aspects of the invention can be advantageously used. Numerical simulations for each of the practical scenarios will be discussed with reference to FIGS. 6 to 7, 9 to 10, and 12 to 13, for validating the proposed methods for detecting and resolving the ghost targets. The simulation set-up consists of the transmission of an IEEE 802.11ad frame consisting of the length-Nd=327680 random block-OFDM data samples. The transmitted signal is reflected as the communication echo by multiple (L=2) targets. The echo signal has a delay proportional to the range of the target(s) and a Doppler shift which is proportional to the velocity of the target(s). The received echo signal is processed using the modified transmit OFDM signal as the clean transmit reference signal as described further above. The parameters for evaluating the two segmented AFs are listed in Table-II.

TABLE II
Simulation parameters

| Parameter | Value |
|---|---|
| Number of samples (N) | 327680 |
| Bandwidth | 1760 MHz |
| (K₁, M₁) | (640, 512) |
| (K₂, M₂) | (682, 480) |
| (R_{max, 1}, R_{max, 2}) | (54.54, 40.90) m |

The received echo signal is assumed to be noise-less, i.e., the simulations are assumed to be noiseless. The maximum number of iterations was set to P₀=2.

FIG. 5 shows a first exemplary relative placement of objects for JRC detection. An egovehicle 10 is equipped with a transmitter and receiver configured for JRC in accordance with the methods of aspects of the present invention. A first target vehicle 20 is within the detectable range, i.e., r₁<R_{max,1}, while a second target vehicle 30 is outside of the detectable range, i.e., r₂>R_{max,1}. The ground truth for the targets are (r₁, v₁)=(3.835 m, 41.85 m/s) and (r₂, v₂)=(56.25 m, 20.93 m/s) respectively.

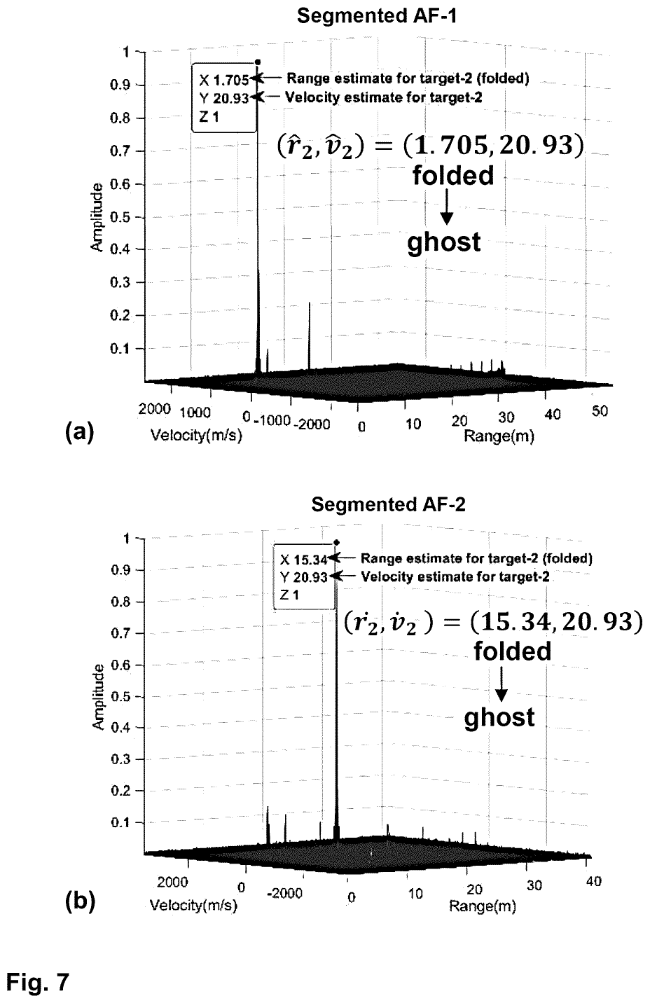

FIGS. 6 and 7 show the corresponding segmented ambiguity functions AF-1 and AF-2 for different segment lengths and for iteration P=1 and P=2, respectively, for the example of FIG. 5. The following observations can be made from FIGS. 6 and 7:

FIG. 6A shows the segmented AF-1 and FIG. 6B shows the segmented AF-2, for the first segment length. Only one significant peak is visible in both segmented AF-1 and segmented AF-2. The peak in segmented AF-1 corresponds to the location and velocity (\hat{r}₁, \hat{v}₁)=(3.835 m, 41.85 m/s) and the peak in segmented AF-2 corresponds to the location and velocity (r̅₁, \dot{v}₁)=(3.835 m, 41.85 m/s). As \hat{r}₁=\dot{r}₁, the segmented AF outputs correspond to the ground truth. Hence, no disambiguation is required, and the location and velocity estimate of the first target vehicle is set to (\hat{r}₁, \hat{v}₁)=(3.835 m, 41.85 m/s).

FIG. 7A shows the segmented AF-1 and FIG. 7B shows the segmented AF-2, for the second segment length. FIGS. 7A and 7B likewise show that there is only one significant peak in both segmented AF-1 and segmented AF-2. The peak in segmented AF-1 corresponds to the location and velocity (\hat{r}₂, \hat{v}₂)=(1.705 m, 20.93 m/s) and the peak in segmented AF-2 corresponds to the location and velocity (\dot{r}₂, \dot{v}₂)=(15.34 m, 20.93 m/s). Since \hat{r}₂≠\dot{r}₂, the CRT is used to estimate the ambiguity order \hat{m}=1. Accordingly, the estimate of the second target vehicle is determined as (\hat{r}₂, \hat{v}₂)=((54.54+1.705) m, 20.93 m/s)=(56.25 m, 20.93 m/s).

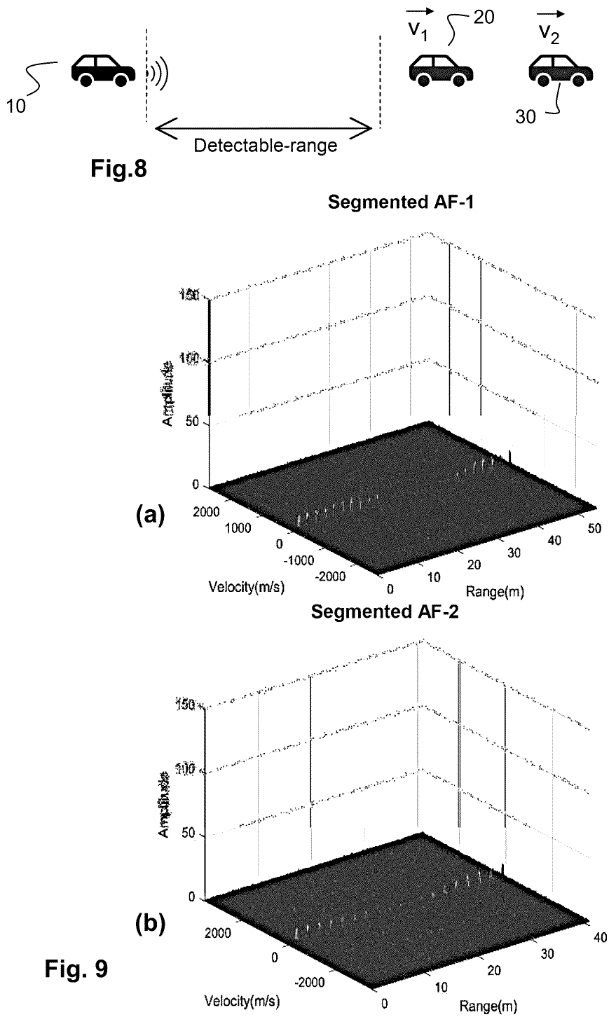

FIG. 8 shows a second exemplary relative placement of objects for JRC detection. An egovehicle 10 is equipped with a transmitter and receiver configured for JRC in accordance with the methods of aspects of the present invention. Both a first target vehicle 20 and a second target vehicle 30 are outside of the detectable range, i.e., (r₁, r₂)>R_{max,1}, and both target vehicles have respective different velocities. The ground truth for the targets are (r₁, v₁)=(56.25 m, 41.85 m/s) and (r₂, v₂)=(58.38 m, 41.85 m/s) respectively.

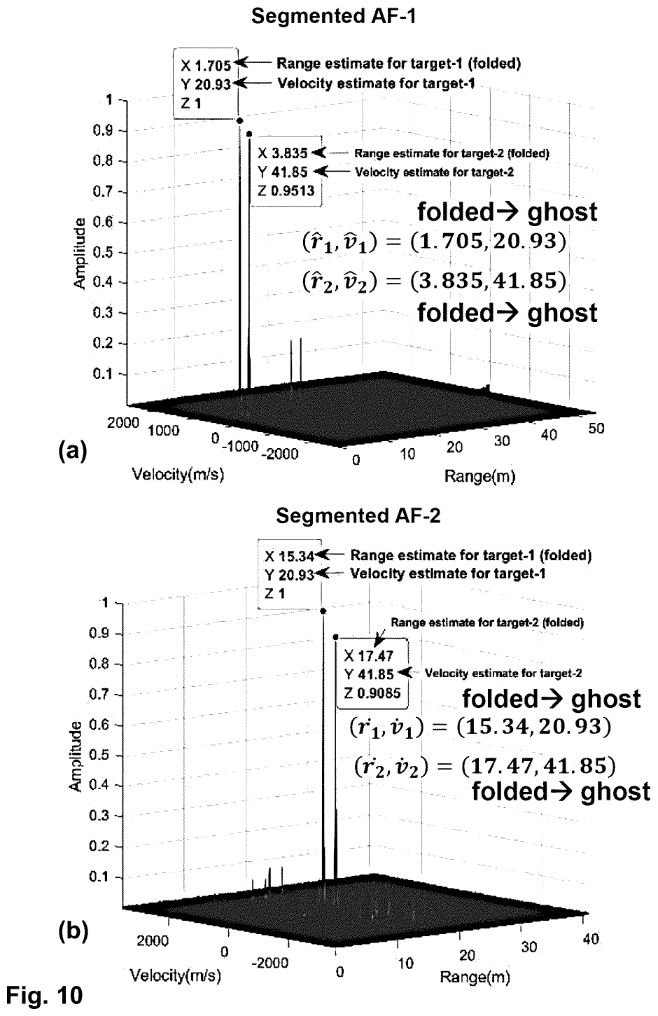

FIGS. 9 and 10 show the corresponding segmented ambiguity functions AF-1 and AF-2 for different segment lengths and for iteration P=1 and P=2, respectively, for the example of FIG. 8. The following observations can be made from FIGS. 9 and 10:

FIGS. 9A and 9B show that there are no significant peaks in either of the segmented AFs. Hence, this iteration does not produce any output, and the method moves to the next iteration.

FIGS. 10A and 10B show that there are two peaks in both segmented AF-1 and segmented AF-2. The peaks in segmented AF-1 correspond to the locations and velocities (\hat{r}₁, \hat{v}₁)=(1.705 m, 20.93 m/s) and (\hat{r}₂, \hat{v}₂)=(3.835 m, 41.85 m/s), respectively. Similarly, the peaks in segmented AF-2 correspond to the locations and velocities (\dot{r}₁, \dot{v}₁)=(15.34 m, 20.93 m/s) and (\hat{r}₂, \dot{v}₂)=(17.47 m, 41.85 m/s), respectively.

Since \hat{r}₁≠\dot{r}₁, \hat{r}₂≠\dot{r}₂ and \hat{v}₁=\hat{v}₂, the peaks (\hat{r}₁, \hat{v}₁)↔(\dot{r}₁, \dot{v}₁) and (\hat{r}₂, \hat{v}₂)↔(\dot{r}₂, \dot{v}₂), respectively, are paired, and the CRT is used to estimate the ambiguity orders \hat{m}₁=\hat{m}₂=1. The estimates of the two target vehicles are determined as (\hat{r}₁, \hat{v}₁)=((54.54+1.705) m, 20.93 m/s)=(56.25 m, 20.93 m/s) and (\hat{r}₂, \hat{v}₂)=((54.54+3.835) m, 41.85 m/s)=(58.38 m, 41.85 m/s).

FIG. 11 shows a third exemplary relative placement of objects for JRC detection. An egovehicle 10 is equipped with a transmitter and receiver configured for JRC in accordance with the methods of aspects of the present invention. Both a first target vehicle 20 and a second target vehicle 30 are outside of the detectable range, i.e., (r₁, r₂)>R_{max,1}, and both target vehicles have the same velocity. The ground truth for the targets are (r₁, v₁)=(56.25 m, 20.93 m/s) and (r₂, v₂)=(58.38 m, 20.93 m/s) respectively.

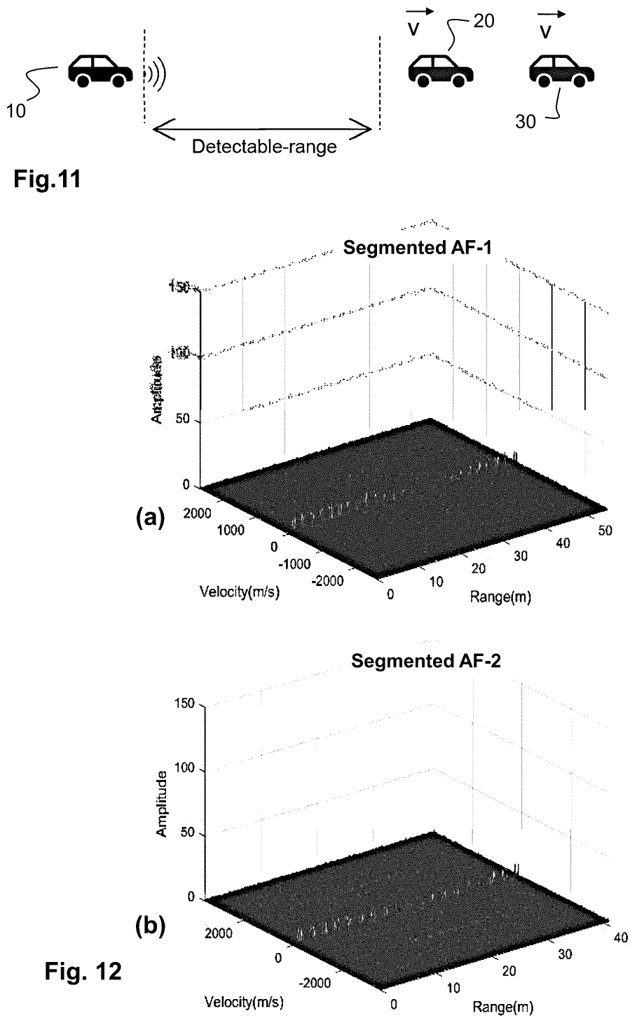

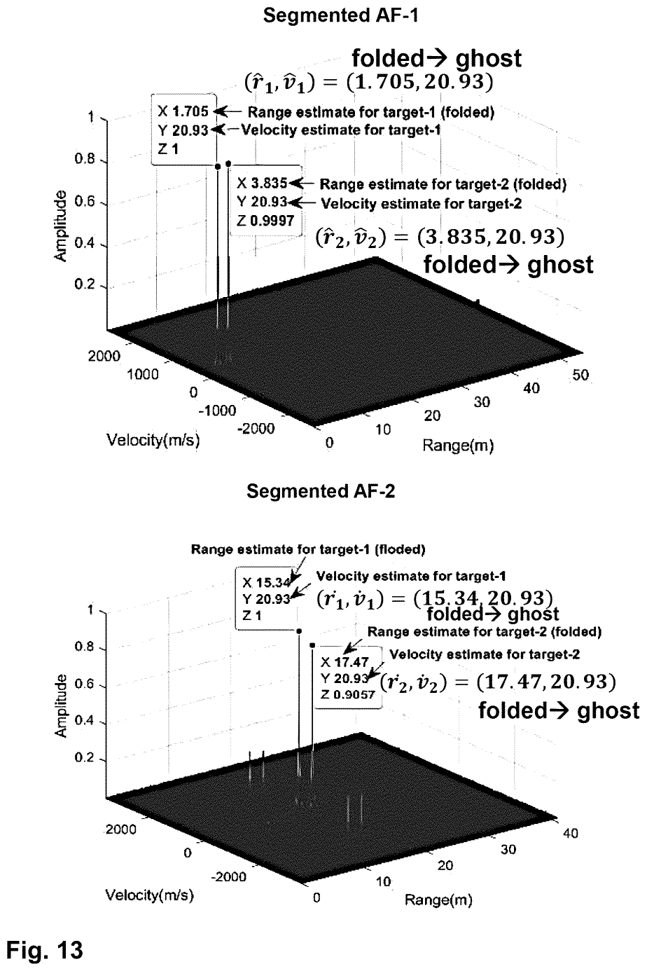

FIGS. 12 and 13 show the corresponding segmented ambiguity functions AF-1 and AF-2 for different segment lengths and for iteration P=1 and P=2, respectively, for the example of FIG. 11. The following observations can be made from FIGS. 12 and 13:

FIGS. 12A and 12B show that there are no significant peaks in either of the segmented AFs. Hence, this iteration does not produce any output, and the method moves to the next iteration.

FIGS. 13A and 13B show that there are two peaks in both segmented AF-1 and segmented AF-2. The peaks in segmented AF-1 correspond to the locations and velocities (\hat{r}₁, \hat{v}₁)=(1.705 m, 20.93 m/s) and (\hat{r}₂, \hat{v}₂)=(3.835 m, 20.93 m/s), respectively. Similarly, the peaks in segmented AF-2 correspond to the locations and velocities (\dot{r}₁, \dot{v}₁)=(15.34 m, 20.93 m/s) and (\dot{r}₂, \dot{v}₂)=(17.47 m, 20.93 m/s), respectively.

Quite obviously, \hat{r}₁≠\dot{r}₁, \hat{r}₁≠\dot{r}₂ and \hat{v}₁≠\hat{v}₂. However, \hat{v}₁=\hat{v}₂, hence peak pairing is not possible. Accordingly, the ambiguity orders \hat{m}₁=\hat{m}₂ are set to (P−1)=1. The estimates of the two target vehicles are determined as (\hat{r}₁, \hat{v}₁)=((54.54+1.705) m, 20.93 m/s)=(56.25 m, 20.93 m/s) and (\hat{r}₂, \hat{v}₂)=((54.54+3.835) m, 20.93 m/s)=(58.38 m, 20.93 m/s).

The simulations show that the proposed methods are able to successfully detect and resolve ghost peaks in the radar sensing image which occur due to range folding.

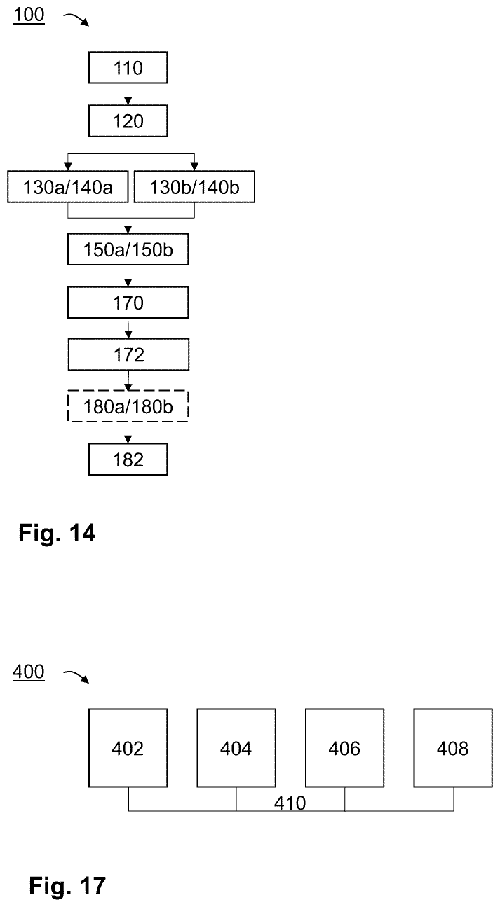

FIG. 14 shows a basic schematic flow diagram of the inventive method 100. In step 110 a reflection, or echo, of a previously transmitted communication signal is received. In step 120 a copy of the corresponding transmitted signal is retrieved. In steps 130a, 140a the received signal and the reference signal are segmented into first segments of a first length K₁. In step 130b, 140b the received signal and the reference signal are segmented into second segments of a second length (K₂) that is different from that of the first segment length (K₁). In step 150a, 150b the ambiguity functions for corresponding first and second segments are segment-wise evaluated, for obtaining, in step 170, first (\hat{r}ₗ) and second (\dot{r}ₗ) range estimates and first (\hat{v}ₗ) and second (\dot{v}ₗ) velocity estimates for one or more targets (l). In optional step 180a, 180b ghost signals that may have been determined in step 172 are resolved or ambiguity values are assigned to non-resolvable results, and in step 182 the results are output. While steps 130a/140a and 130b/140b are shown as being executed in parallel it is also possible to execute these steps sequentially.

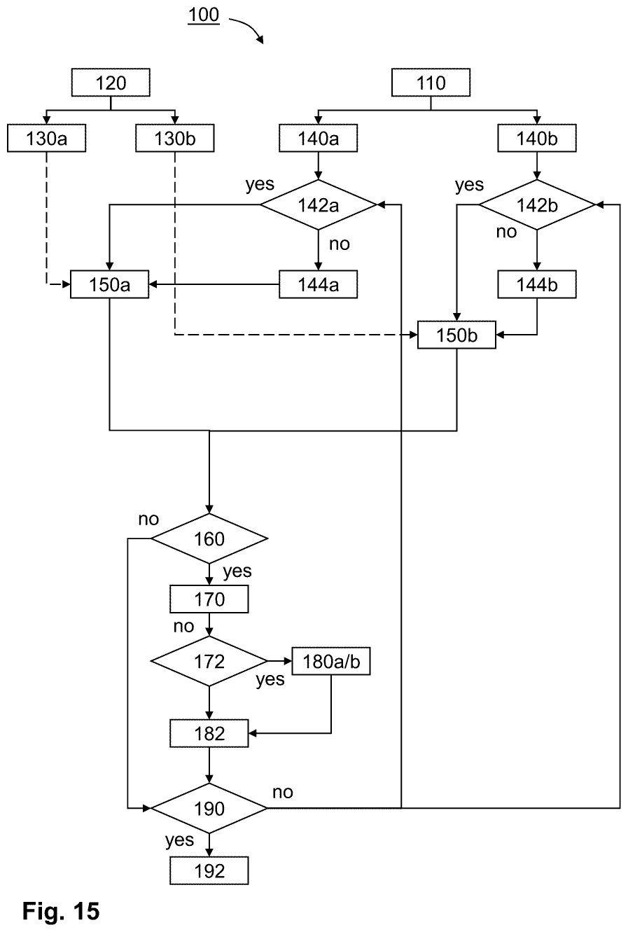

FIG. 15 shows a further, more detailed representation of an exemplary flow diagram of the inventive method. In steps 110 and 120, respectively, a reflected communication signal and a copy of the corresponding previously transmitted communication signal are received or retrieved, respectively. In steps 130a and 130b, respectively, copies of the retrieved transmitted signal, which represents a reference signal, are segmented into first numbers of first-length segments and second numbers of second-length segments, respectively, and are arranged in corresponding first and second reference matrices, which are provided to steps 150a and 150b, respectively. As these steps are carried out only once, and the provided matrices are reused in each iteration, the providing is indicated by the dashed arrows. Correspondingly, in steps 140a and 140b, respectively, copies of the received reflected communication signal are segmented into first numbers of first-length segments and second numbers of second-length segments, respectively, and are arranged in corresponding first and second received communication signal matrices. In step 142a and 142b a check is made if this is the first iteration of a subsequent iterative process. If so, “yes”-branches of steps 142a and 142b, the matrices are provided directly to steps 150a and 150b, respectively, and the method proceeds with steps 150a and 150b, in which first and second ambiguity functions are evaluated based on the first and second reference matrices and the corresponding first and second received communication signal matrices. Otherwise, “no”-branches of steps 142a and 142b, the received communication signal matrices are modified in steps 144a, 144b, by deleting the left-most columns and appending zero-columns to the right, prior to being provided to steps 150a and 150b, respectively. In steps 150a and 150b first and second ambiguity functions are evaluated based on the first and second reference matrices and the correspondingly first and second received communication signal matrices, original or modified. In step 160 a check is made if any of the first and second ambiguity function has a peak exceeding a predetermined threshold.

In the positive case, “yes”-branch of step 160, the method obtains, in step 170, first and second range estimates and first and second velocity estimates for one or more targets from the first and second segmented ambiguity functions. In step 172 the method checks if ghost signals are present in the estimates. In the positive case, “yes”-branch of step 172, the method resolves the ghost signals or assigns an ambiguity order to the estimates in steps 180a or step 180b, respectively. The obtained or resolved range and velocity estimates, or the estimates and the assigned ambiguity order, for the current iteration, are output in step 182. If no ghost signals are present in the estimates, “no”-branch of step 172, the method directly continues with step 182.

If none of the first and second ambiguity function has a peak exceeding the predetermined threshold, “no”-branch of step 160, the method continues with step 190.

In step 190 the method checks if a termination criterion is met. In the positive case, “yes”-branch of step 190, the method terminates, step 192. In the negative case, “no”-branch of step 190, the method performs a further iteration, beginning in steps 142a and 142b, respectively.

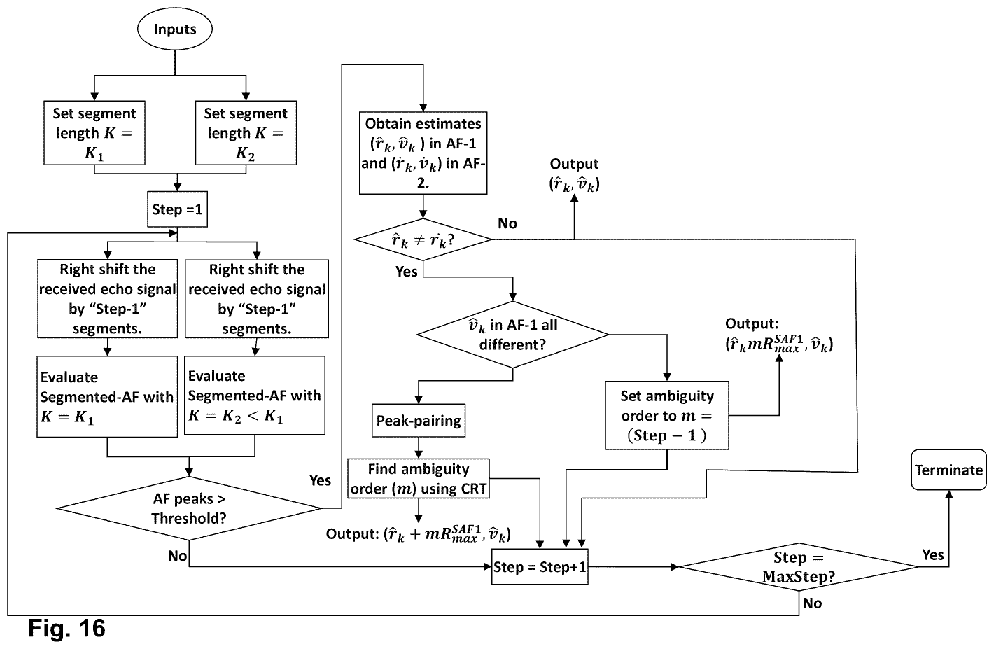

FIG. 16 shows yet another, more detailed representation of an exemplary flow diagram of the inventive method 100. The various steps are explained in the figure and will not be discussed in detail here.

FIG. 17 shows a schematic block diagram of an exemplary receiver 400 configured for executing the inventive method. An antenna 402, a microprocessor 404, volatile memory 406 and non-volatile memory 408 are connected by one or more signal and/or data lines or buses 410. The non-volatile memory 408 stores computer program instructions which, when executed by the microprocessor 404 configure the receiver 400 for performing the method in accordance with an aspect of the invention.

LIST OF REFERENCE NUMERALS
(PART OF THE DESCRIPTION)

| | | | |
|---|---|---|---|
| 100 | method | 170 | obtain AFs |
| 110 | receive echo | 172 | ghosts detected? |
| 120 | retrieve reference signal | 180a | resolve ghosts |
| 130a, | | 180b | assign ambiguity to |
| | | | estimates |
| 140a | segment into first length | 182 | output estimates |
| 103b, | | 190 | termination criterion met? |
| 140b | segment into second length | 192 | terminate method |
| 142a, | | 400 | wireless communication |
| 142b | first iteration? | | apparatus |
| 144a, | | 402 | antenna |
| 144b | modify matrices | 404 | microprocessor |
| 150a, | | 406 | volatile memory |
| 150b | evaluate ambiguity | 408 | non-volatile memory |
| | functions | | |
| 160 | peak detected? | 410 | signal/data line/bus |

1. A method of processing communication signals for use in radar sensing comprising:
a) receiving a reflected communication signal, wherein the reflected received communication signal is a reflection of a transmitted communication signal, and storing the received communication signal in a receiver buffer,
b) retrieving a copy of the corresponding transmitted communication signal, representing a reference signal, from a reference buffer,
c) segmenting the reference signal into a first segment-number of first-length segments and segmenting the reference signal into a second segment-number of second-length segments, and arrange the first-length and the second-length-segments in respective first and second reference signal matrices,
d) segmenting the received communication signal into a first segment-number of first-length segments and segmenting the received communication signal into a second segment-number of second-length segments, and arranging the first-length and the second-length segments in respective first and second received communication signal matrices,
e) evaluating first and second segmented ambiguity functions based on the first and second received communication signal matrices and the corresponding first and second reference signal matrices, respectively,
f) obtaining, from the first and second segmented ambiguity functions, first and second range estimates and first and second velocity estimates, for one or more targets,
g) on any obtained first and second range and/or first and second velocity estimate, determining if ghost signals are present in the estimates and, in the positive case, resolving the ghost signals or assigning an ambiguity order to the estimates,
h) outputting the obtained or resolved range and velocity estimates, or the estimates and the assigned ambiguity order,
i) iteratively repeating steps e) to h) until a termination criterion is met wherein, in the second and each further iteration a respective remaining left-most non-zero column of the first and second received communication signal matrices are removed, and a right-most zero-column is appended.

2. The method of claim 1, wherein steps c) and d) comprise, for the reference signal and the received communication signal:
collecting a first-length number of consecutive samples of the respective signal to form segments of the first length,
repeating the previous step the first segment-number times,
forming respective matrices of size first segment-number×first length for the reference signal and for the received communication signal from the corresponding segments,
and
collecting a second-length number of consecutive samples of the respective signal to form segments of the second length,
repeating the previous step the second segment-number times,
forming respective matrices of size second segment-number×second length for the reference signal and for the received communication signal from the corresponding segments.

3. The method of claim 1, wherein evaluating the first and second segmented ambiguity function comprises:
performing a first Fourier transform on the columns of the received communication signal matrices and the reference signal matrices, for obtaining corresponding matrices in the frequency domain,
determining the Hadamard product of the received communication signal matrices and the reference signal matrices, for obtaining first further matrices representing the received communication signal in the frequency domain,
performing a first inverse Fourier transform on the columns of the first further matrices representing the received communication signal to form corresponding second further matrices representing the received signal in the time domain,
performing a second Fourier transform on the rows of the second further matrices representing the received signal to obtain matrices representing the first and the second segmented ambiguity function, respectively,
performing peak searches on the matrices representing the first and the second segmented ambiguity function, and
outputting information representing the range and the velocity corresponding to the peaks found in the preceding step.

4. The method of claim 1, wherein obtaining, from the first and second segmented ambiguity functions, first and second range estimates and first and second velocity estimates, for one or more targets comprises:
determining if the first and/or second segmented ambiguity functions exhibit peaks that exceed a predetermined threshold and, in the negative case:
proceeding to the next iteration.

5. The method of claim 1, wherein determining if ghost signals are present in the range and/or velocity estimates comprises:
segment-wise comparing the first and second range estimates, and
if the first and second range estimates for a set of corresponding segments correspond, outputting the range and velocity estimates for the one or more targets for this iteration in step h),
or,
if the first and second range estimates for a set of corresponding segments do not correspond and the first velocity estimates are all different, pairing the first and second, range and velocity estimates for each target based on their respective velocity estimates, determining an ambiguity order, and outputting the first velocity estimate and a range estimate for this iteration in step h), wherein the range estimate is assigned an ambiguity order determined using the Chinese remainder theorem-method,
or,
if the first and second range estimates for a set of corresponding segments do not correspond and some of the first velocity estimates are equal, setting an ambiguity order to the number of the current iteration minus 1 and outputting the first velocity estimate and a range estimate in step h), wherein the range estimate is assigned the set ambiguity.

6. The method of claim 1, wherein the communication signals are in compliance with the IEEE 802.11ad standard.

7. The method of claim 1, wherein the reference signal for a single-carrier transmission is a plain copy of the transmitted signal.

8. The method of claim 1, wherein the reference signal for an orthogonal frequency division multiplex transmission is a modified copy of the transmitted communication signal, and wherein the method further comprises, prior to the segmenting step:
replacing a cyclic prefix in the copy of the transmitted communication signal with zero or replacing the cyclic prefix with a zero-prefix.

9. The method of claim 1, wherein the reference signal for an OFDM transmission is a modified copy of the transmitted communication signal, and wherein the method further comprises, prior to the segmenting step:
setting the trailing symbols of the transmit OFDM symbol that are used for a cyclic prefix in the transmitted communication signal to zero.

10. A wireless communication apparatus adapted for joint radar and wireless communication, comprising at least one transmitting and receiving antenna, a microprocessor and associated volatile and non-volatile memory, wherein the non-volatile memory stores computer program instructions which, when executed by the microprocessor, configure the wireless communication apparatus for performing the method of claim 1.

11. A computer program product comprising instructions, which, when the program is executed by a microprocessor, cause a computer and/or control hardware blocks, modules or components of a wireless communication apparatus comprising at least one transmitting and receiving antenna, a microprocessor and associated volatile and non-volatile memory to carry out the method of claim 1.

12. (canceled)

13. (canceled)

14. A wireless communication apparatus adapted for joint radar and wireless communication, comprising at least one transmitting and receiving antenna, a microprocessor and associated volatile and non-volatile memory, wherein the non-volatile memory stores computer program instructions which, when executed by the microprocessor, configure the wireless communication apparatus for performing the method of claim 2.

15. A computer program product comprising instructions, which, when the program is executed by a microprocessor, cause a computer and/or control hardware blocks, modules or components of a wireless communication apparatus comprising at least one transmitting and receiving antenna, a microprocessor and associated volatile and non-volatile memory to carry out a method of claim 2.

16. A wireless communication apparatus adapted for joint radar and wireless communication, comprising at least one transmitting and receiving antenna, a microprocessor and associated volatile and non-volatile memory, wherein the non-volatile memory stores computer program instructions which, when executed by the microprocessor, configure the wireless communication apparatus for performing the method of claim 3.

17. A computer program product comprising instructions, which, when the program is executed by a microprocessor, cause a computer and/or control hardware blocks, modules or components of a wireless communication apparatus comprising at least one transmitting and receiving antenna, a microprocessor and associated volatile and non-volatile memory to carry out a method of claim 3.

18. A wireless communication apparatus adapted for joint radar and wireless communication, comprising at least one transmitting and receiving antenna, a microprocessor and associated volatile and non-volatile memory, wherein the non-volatile memory stores computer program instructions which, when executed by the microprocessor, configure the wireless communication apparatus for performing the method of claim 4.

19. A computer program product comprising instructions, which, when the program is executed by a microprocessor, cause a computer and/or control hardware blocks, modules or components of a wireless communication apparatus comprising at least one transmitting and receiving antenna, a microprocessor and associated volatile and non-volatile memory to carry out a method of claim 4.

20. A wireless communication apparatus adapted for joint radar and wireless communication, comprising at least one transmitting and receiving antenna, a microprocessor and associated volatile and non-volatile memory, wherein the non-volatile memory stores computer program instructions which, when executed by the microprocessor, configure the wireless communication apparatus for performing the method of claim 5.

21. A computer program product comprising instructions, which, when the program is executed by a microprocessor, cause a computer and/or control hardware blocks, modules or components of a wireless communication apparatus comprising at least one transmitting and receiving antenna, a microprocessor and associated volatile and non-volatile memory to carry out a method of claim 5.
